(19) United States
(12) Patent Application Publication
(10) Pub. No.: US 2011/0302995 A1
(43) Pub. Date: Dec. 15, 2011

(54) Wide range fluid leak detector and flow meter

(76) Inventors: Lawrence W. Lebeau, Park City, UT (US); Richard Zapolin, Lexington, MA (US)

(21) Appl. No.: 12/802,844

(22) Filed: Jun. 15, 2010

(51) Int. Cl. G01M 3/00; G01F 15/02

(52) U.S. Cl. 73/40; 73/861.01

(57) ABSTRACT

A flowmeter is provided with a solid-state sensor technology for increasing the accuracy and efficiency of fluid flow monitoring and leak detection in the irrigation industry and other cost-sensitive flow-critical applications. The device can monitor and detect usage of fluids such as water more accurately and economically than presently possible to help eliminate waste and ensure correct billing. Measurement can be over an optimized narrow range or can be automatically switched to cover consecutive ranges from leakage to gross fluid conduit faults. With its minimal component count, ease of assembly, independence from the specifics of its housing, low maintenance needs, and its interchangeability this device can serve a wide range of metering needs from low end leak monitoring to standard flow measurement.

### BACKGROUND OF THE INVENTION

### Field

The present invention relates to an inherently-low-cost approach to monitoring for fluid leaks ranging from small to large. More particularly the present invention relates to a system and methods for using minimal solid-state sensing and minimal packaging to recognize that fluid is flowing even down at nominal shutoff conditions. It offers the unique ability to provide a wide range of flow monitoring, ranging from smaller leaks than any other system currently available can detect to the maximum flow resulting from breakage of piping and flow elements. A single solid state element combines both a heater and a temperature sensor for the fluid as it leaks past the sensing position simplifying assembly and minimizing setup complexity. Commodity-type housings to add onto or drop into piping can complete the economical but powerful system.

### REFERENCES CITED

| Patent # | Patentee | Issue Date |
|---|---|---|
| 5,553,505 | Bignell, et al. | Sep. 10, 1996 |
| 5,637,789 | Lawson | Jun. 10, 1997 |
| 6,487,904 | Myhre | Dec. 3, 2002 |
| 6,637,264 | Lotters, et al. | Oct. 28, 2003 |
| 6,644,133 | Williams | Nov. 11, 2003 |
| 6,672,154 | Yamagishi, et at | Jun. 6, 2004 |
| 6,813,944 | Mayer, et al. | Sep. 9, 2004 |
| 7,054,767 | Eldridge | May. 6, 2006 |
| 7,058,532 | Yamahishi, et al. | Jun. 6, 2006 |
| 7,337,661 | Yamada, et al. | Mar. 4, 2008 |
| 7,437,951 | McDonald, et al. | Oct. 21, 2008 |
| 7,444,863 | Sakai | Nov. 4, 2008 |
| 7,587,948 | Gysling, et al. | Sep. 15, 2009 |

### PRIOR ART

In many flow metering applications i.e. irrigation, there is a need for recognizing that flow leakage is occurring even while the system is nominally shutdown. Existing meters suffer from inability to respond to small flows, inability to keep responding when unwanted flows reach the maximum capacity of the piping, and inherent complexity that drives up their cost and makes them inappropriate for many applications in which monitor prices are a limiting factor.

Prior art involving heat and heat detection in the presence of fluid flow involve unnecessary complexity in that they add additional elements that are not needed, particularly in the common case of water flowing under pressure through pipes. U.S. Pat. No. 6,813,944 by Mayer, et al., U.S. Pat. No. 7,444,863 by Sakai, U.S. Pat. No. 7,058,532 by Yamaghishi, et al., U.S. Pat. No. 6,637,264 by Lotters, et al., U.S. Pat. No. 6,672,154 by Yamaghishi, et al., and U.S. Pat. No. 6,487,904 by Myhre require a second sensor to sense temperature in the flow upstream of where the heat is applied. U.S. Pat. No. 5,553,505 by Bignell, et al. needs four SiC sensing chips. U.S. Pat. No. 7,054,767 by Eldridge requires a second RTD thermal sensor to provide temperature correction. However, in the most common application involving water under pressure flowing through pipes the water temperature is stable and low compared to the highly heated thermistor used in the present invention obviating the need for temperature compensation. U.S. Pat. No. 7,337,661 by Yamada, et al. and U.S. Pat. No. 7,058,532 by Yamaghishi, et al. specify two thermistors and a separate heater. The present invention uses a single sensor which also serves as the heat source. U.S. Pat. No. 7,587,948 by Gysling, et al. requires at least two pressure sensors to determine the pressure fluctuations caused by flow. U.S. Pat. No. 7,587,948 by Gysling, et al. requires two acoustic transducers and matching sensors to get velocity from phase.

U.S. Pat. No. 6,813,944 by Mayer, et al. and U.S. Pat. No. 6,644,133 by Williams make use of sensing on the exterior of the tube through which the fluid is flowing and making use of the thermal conductivity of that tube. That makes it inapplicable to applications in which the flow is passing though PVC or similar non-metallic tubes in which the tube wall is a poor conductor of heat. The present invention avoids that pitfall by inserting the sensor directly into the interior of the tube so that contact is with the fluid and sensitivity to heat dissipation is at its maximum.

U.S. Pat. No. 5,637,789 by Lawson uses a single self-heated thermistor for low flow monitoring but requires the complication of housing it in a separate tube adding to the complexity and cost of the monitoring means. Moreover this tube that bypasses the plumbing-code-required backflow-prevention means is not permitted in irrigation systems. It constitutes an illegal cross-connection that could permit contamination of the incoming water supply so that metering means could not be used with irrigation systems for which the preferred embodiment of the current invention is well suited. The present invention avoids that pitfall by having its sensor in the main stream without any bypassing.

Current techniques used involve metering elements (such as mechanical paddle wheels and turbines that must be spun by the flow for which U.S. Pat. No. 6,644,133 by Williams is one of several techniques that use a turbine within the fluid to generate pulses proportional to flow), or orifice plates and venture sections that partially block the flow for which U.S. Pat. No. 7,437,951 by McDonald, et al is one of several, or that require extensive calibration whenever the metering element is replaced. These meters also contain parts that must be assembled to high precision and that contain costly components in a specially-prepared housing that sets minimum prices that can be charged for the meter. The present invention avoids that pitfall by using a small solid state sensor with no moving parts and minimal protrusion into the flow.

In the flow metering needs of commercial and residential water metering applications those users may have unnoticed water leakage that totals to significant amounts without that passage of water being detected by the meters as it occurs hiding excess water usage. In addition, cost-conscious applications like outdoor water usage, particularly on the residential level, can not afford meters with high price tags since they drive up the system capital costs to unacceptable levels.

### ADVANTAGES

Metering devices that offer full range for monitoring at an inherently low cost are needed to detect leakage and to fairly show consumption as an aid to minimizing waste.

Accordingly, several advantages of one or more aspects of the invention are ability to respond to all flows from small to full, inherently-lower cost of manufacture that makes them appropriate for many applications in which moderate costs are a requirement, avoidance of moving elements that must be spun by the flow or that partially block the flow or that require extensive calibration whenever the metering element is replaced, ability to dynamically change properties to meet extreme flow conditions, elimination of parts that must be assembled to high precision and that contain costly components in a specially-molded housing.

Other advantages of one or more aspects are the simplicity of design that permits achieving lower manufacturing cost making them appropriate for cost-sensitive applications like outdoor watering, particularly on the residential level, which can not afford meters with high price tags since they drive up the system capital costs to unacceptable levels, and their ability to be configured to match a wide variety of electrical/electronic inputs so that they can offer the benefits of metering and leak detection where it is not presently practical.

Further advantages will become apparent from a consideration of the ensuing description and the accompanying drawings.

### SUMMARY

This metering apparatus combines the sensitivity and interchangeability of solid state sensors with a compact form that fits into appropriate packaging specifically, but not limited to, in this case existing commodity plumbing fittings to provide a detector that avoids the costs and complexity of mechanical-basis meters while providing the range and accuracy expected of computer-supported meters.

The ability of the meter's sensing element to respond to the smallest of flows, hundredths of a gallon per minute, gives it the ability to find leaks that are occurring when the system valves are shut off. Leaks that small at a single location can waste over a hundred gallons per day which totals tens of thousands of gallons per year. In areas with water bans those savings over a municipal area can spell the difference between adequate water supplies using existing facilities versus bans or drought conditions being declared.

In addition to that low end monitoring the meter reports typical usage with standard precision so that water awareness can become a constant caution against wastage.

### DETAILED DESCRIPTION

### DRAWINGS

### BRIEF DESCRIPTION OF THE DRAWINGS

A more complete understanding of the present invention may be derived by referring to the detailed description and claims when considered in connection with the figures, where like reference numbers refer to similar elements throughout the figures, and:

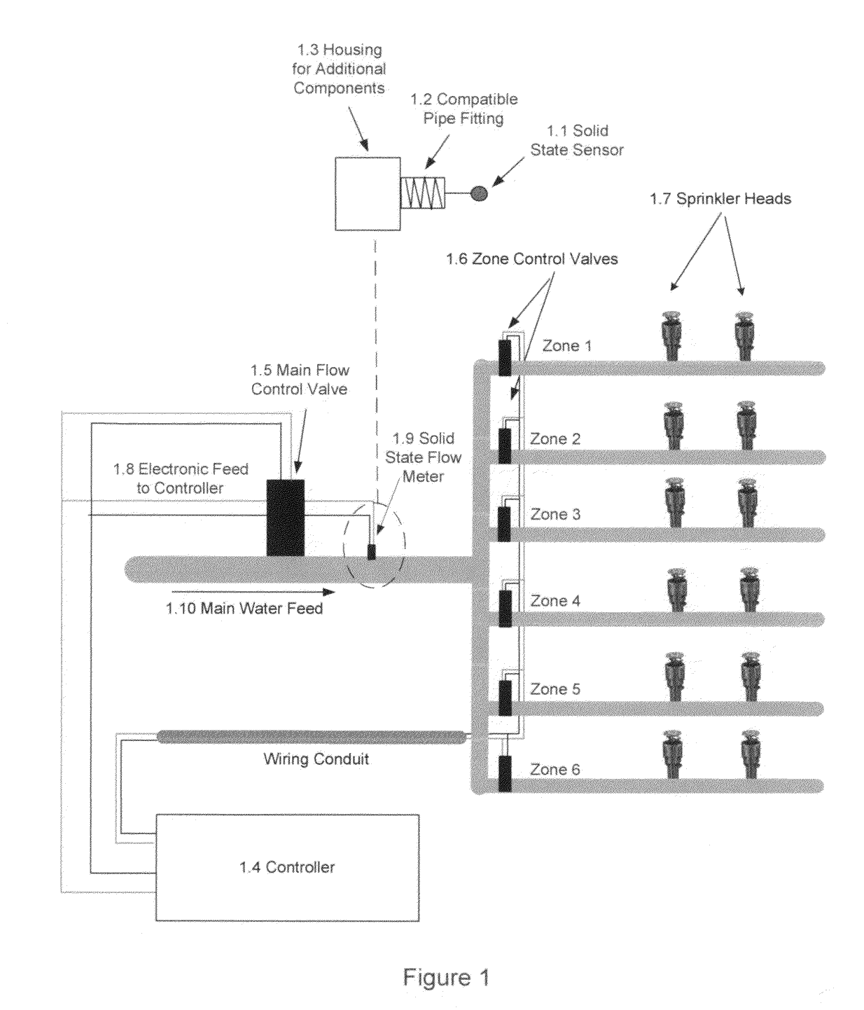

FIG. 1 illustrates a block diagram of a flow metering for an actual water irrigation system utilizing the new solid-state flow monitoring and leak detection device in accordance with the exemplary embodiments.

### DETAILED DESCRIPTION OF EXEMPLARY EMBODIMENTS OF THE INVENTION

The present invention may be described herein in terms of various functional components.

In accordance with various aspects of the present invention, and with reference to FIG. 1, the invention, to be referred to as the “device”1.9 from here on forward, is an electronic solid state flow meter and leak detector, utilizing a solid state sensor 1.1, specifically, but not limited to, in this case a thermistor for 1.1. In the preferred embodiment the use of a self-heated thermistor as the sensor minimizes component count by eliminating the need for temperature compensation or for providing an external heating source and offers a rapid, consistent, and easily-detected change of resistance in response to flow cooling. A series resistor of proper resistance and wattage will limit the sensor's self-heating by functioning as a simple voltage divider for the power supply. If the flow exceeds the range and an alternative self-heat temperature is needed, the controller 1.4 can change the range by automatically selecting alternative series resistors. In the preferred embodiment the sensor would be packaged as a drop-in component in a housing designed to strap onto an existing piping system to minimize the cost and time of installation. In this example of fluid monitoring, the device 1.9 is physically mounted inside the main water feed 1.10 of a water monitoring application specifically, but not limited to, in this case an irrigation outdoor watering system. The solid state sensor 1.1 has the inherent property of using current passed through it for electronically heating itself to a specific temperature designated by hardware and software. That elevated temperature negates the effect of changes in the incoming water temperature, magnifies the effect of the water flow cooling, and makes best use of the steepest portion of the temperature vs. resistance change curve of the sensor 1.1. The device is turned on while there is no water flowing in the system but the pipes are full of water. The device electronically calibrates the voltage fed to the controller 1.4 based on the sensor 1.1 self-heated temperature reaching equilibrium with the water temperature at no flow. When the main flow control valve 1.5 is opened and any of the zone control valves 1.6 are opened, water is dispersed out of the appropriate sprinkler heads 1.7. This action causes a water flow through the main water feed 1.10. The enhanced dissipation of heat from the sensor 1.1 by thermal transfer to the water flowing across the solid state sensor 1.1 causes a significant drop from its self-heated temperature, in turn causing a change in resistance within the solid state sensor 1.1. This change in resistance causes a change in voltage which is being monitored by the controller 1.4. This change in temperature, resistance, and voltage is dependant on the speed of the water flow through the pipe. The voltage is monitored and converted to digital flow rate data for the controller 1.4 to display and utilize for any function desired within the controller 1.4 i.e. extremely accurate flow in gallons per minute, sensitive leak detection, or any system flow malfunctions.

### CONCLUSION, RAMIFICATIONS, AND SCOPE

Accordingly the reader will see that, according to the invention, we have provided the ability to respond to small flows, ability to respond closely to flows reaching the maximum capacity of the piping, inherently-lower cost of manufacture that makes the device appropriate for many applications in which moderate costs are a necessary factor, avoidance of metering elements that must be spun by the flow that partially block the flow or that require extensive calibration whenever the metering element is replaced, elimination of parts that must be assembled to high precision and that contain costly components in a specially-molded housing.

While the above description contains many specificities, these should not be construed as limitations on the scope of the invention, but as exemplifications of the presently preferred embodiments thereof. Many other ramifications and variations are possible within the teachings of the invention. For example, the system could utilize a solid state sensor which responds sharply to temperature differences to provide an on/off signal rather than a proportional one, could use other thermal detection elements such as transistors if less sensitivity is needed, could be located on the top, bottom, or sides of the piping to provide flow monitoring for sewage or drainage gravity systems that do not utilize a full pipe, could be wired into an existing alarm notification to alert a central office of the existence of a fire sprinkler system leak, could be used with an Automatic Meter Reading (AMR) system to provide a minimally-expensive metering element for municipal water service monitoring, could be used with equipment drip pans to alert that leakage flow is occurring, could be used with catheterized post-surgery patients to confirm successful urine flow, could be used in high-flow fire flow meters since it does not block the piping passageway, could be used as a backup safety meter element in a failsafe flow monitoring system, or could even be used in a reverse fashion for a small sailboat or small trolling boat speedometer with the device being fixed to the boat and the boat's travel through the water causing the relative motion for thermal transfer.

Thus the scope of the invention should be determined by the appended claims and their legal equivalents, and not by the examples given.

A method of performing accurate flow monitoring and sensitive leak recognition utilizing state of the art solid state technology in water irrigation systems in all industries including, but, not limited to landscaping, farmlands, vineyards, fire-sprinkling systems etc, or in any other fluid flow monitoring system.

1) A system comprising a sensitive and robust solid state sensor-based means for leak detection and for fluid flow monitoring with minimal components and housing for use in applications in which instrumentation cost is a limiting consideration.

2) The system as claimed in claim 1, in which the measured leakage or flow is occurring in piping or in open or closed pans, sewer drains, open streams, and other non-pressurized fluid conduits.

3) The system as claimed in claim 1, in which the relative flow past the sensor is caused by its movement through a body of water to measure an instrumented watercraft's speed.

4) The system as claimed in claim 1, further comprising an alarm to notify the user or monitoring agency of the flow fault.

5) The system as claimed in claim 1, further comprising a means such as an electrical valve for stopping the flow of the fluid.

6) The system as claimed in claim 1, comprising the solid-state sensor that responds detectably to the change in heat dissipation caused by very small flows, such as those of leaks or chemical dosing.

7) The system as claimed in claim 1, comprising a solid-state sensor with sufficient range of response to accurately sense fluid flow up to the maximum of the piping or the non-pressurized fluid conduit.

8) The system as claimed in claim 1, comprising a solid-state sensor with sufficient range of response to accurately sense fluid flow up to the maximum of the piping or the non-pressurized fluid conduit.

9) The system as claimed in claim 1, comprising sensors that are available embedded in glass or other inert material to be usable in a variety of fluids without contamination of the fluid or deterioration of the sensor.

10) The system as claimed in claim 1, comprising sensors that are interchangeable and robust so that they do not need re-calibration on replacement and can withstand fluctuations in temperature during operation or piping failure.

11) The system as claimed in claim 1, utilizing the sensor's inherent electrical heating when a voltage is applied, to raise its temperature high-enough above the monitored fluid's temperature so that cooling-effected changes in electrical properties are sharpened without the need for temperature compensation in the most common applications.

12) The system as claimed in claim 1, using a thermistor in the dual role of the sensor and the heat source.

13) The system of claim 1, comprising a tiny sensor that will not block the flow or drop the pressure in the piping making it useful for small delicate flows or full pipe high volume metering.

14) The system as claimed in claim 1, with the ability to dynamically widen the sensor's metering range during use by swapping-in a multiplicity of alternative self-heat temperature settings to accommodate extremes of fluid flow cooling.

15) The system as claimed in claim 1, comprising the swapping-in to take advantage of the sensor's full range of temperature vs. resistance properties as preferably a function performed by a monitoring controller external to this invention to minimize the meter's cost and complexity.

16) The system as claimed in claim 1, in which the range-extending means would be by functionality added at the meter itself where economical.

17) The system as claimed in claim 1, in which the said monitoring controller would be a CPU.

18) The system as claimed in claim 1, comprising output that can be customized by the use of sensing elements that respond sharply or smoothly to the cooling effects of the fluid stream to provide either a switching change in resistance or a quantitative one depending on needs of the algorithms of the control system.

19) The system as claimed in claim 1, in which the control system is a minimal indicator or relay without a sophisticated control algorithm to offer a warning or shutdown.

20) The system as claimed in claim 1, comprising an analog or a frequency or a switching output with minimal additional signal conditioning components to provide compatibility with the inputs of control systems.

21) The system as claimed in claim 1, comprising the sensor compact-enough to fit in tight locations where large-body standard meters could not be installed, exploiting the minimal parts required in this system.

22) The system as claimed in claim 1, comprising the sensing means that is independent of the specific configuration of the meter and its piping so that no special precision housings are needed.

23) The system as claimed in claim 1, comprising a number of meter components minimal and simple enough to lower the assembly's parts and labor costs and to avoid precision setup steps in manufacture.

24) The system as claimed in claim 1, comprising the absence of moving parts to give the meter long life with no mechanical wear-out or maintenance.

25) The system as claimed in claim 1, comprising sufficient simplicity to give potential for high-quantity low-cost manufacture that will open many new applications to fluid metering including water conservation needs for which metering instrumentation is currently uneconomical.
